(19) United States
(12) Patent Application Publication
(10) Pub. No.: US 2002/0117995 A1
(43) Pub. Date: Aug. 29, 2002

(54) Charger

(76) Inventor: Se Kwang Oh, Seoul (KR)

Correspondence Address: BIRCH STEWART KOLASCH & BIRCH, PO BOX 747, FALLS CHURCH, VA, 22040-0747, US

(21) Appl. No.: 10/028,760

(22) Filed: Dec. 28, 2001

(30) Foreign Application Priority Data
Dec. 28, 2000 (KR) 2000-0036719

(51) Int. Cl. H02J 7/00

(52) U.S. Cl. 320/107

(57) ABSTRACT

The present utility is related to a charger, which charges charging batteries. In particular, the present utility is designed to charge the charging batteries of different sizes by inserting the charging batteries from the same height and therefore the charging circuit is simplified, volume is minimized and putting in and out the charging batteries are easy.

In order to achieve the objects above, batteries holding parts in which different size batteries can be inserted at the same height inside the charger are formed to cross each other and each point of contacts installed inside the battery holding part are not connected to one another but formed to be connected individually to the circuit. Therefore, volume and especially the thickness of the charger are minimized and each of the batteries are charged adequately according to its types and capacities and it is designed to take out the batteries easily once they are charged.

### REPRESENTATIVE FIGURE

FIG. 3

### INDEX WORDS

charger, charging battery, battery holding part, contact point, crossing

### NAME OF THE UTILITY

Charger

### BRIEF DESCRIPTION OF DRAWINGS

FIG. 1 is a view of the conventional charger.

FIG. 2 is a cross sectional view according to the line AA shown in FIG. 1.

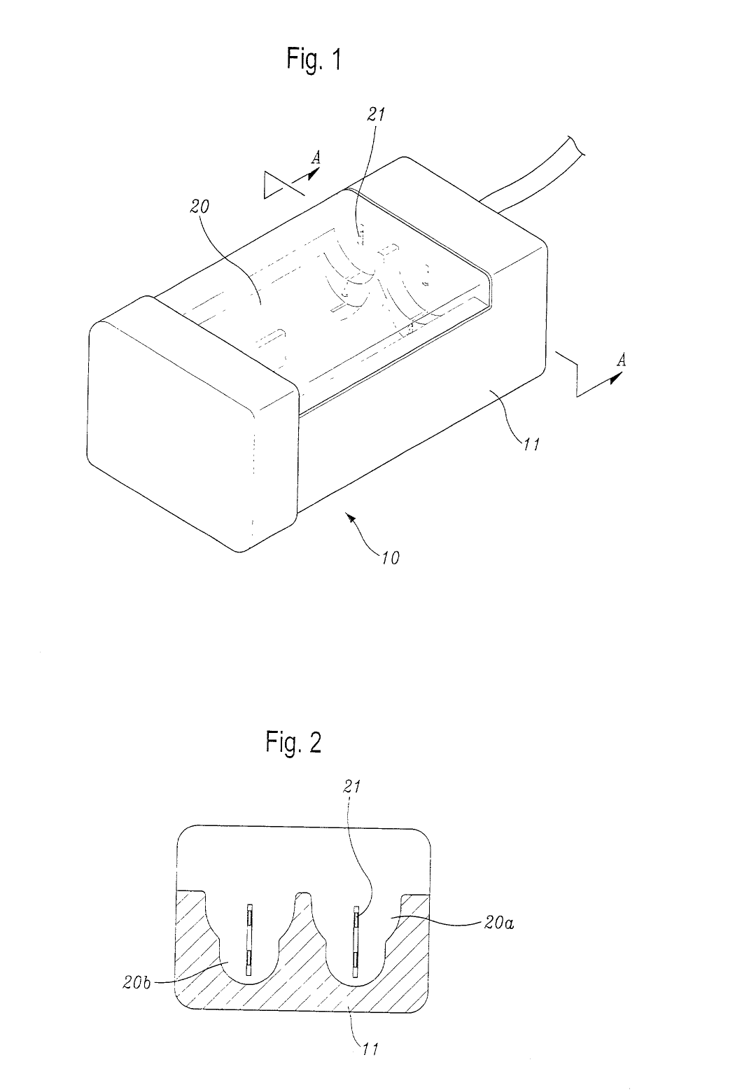

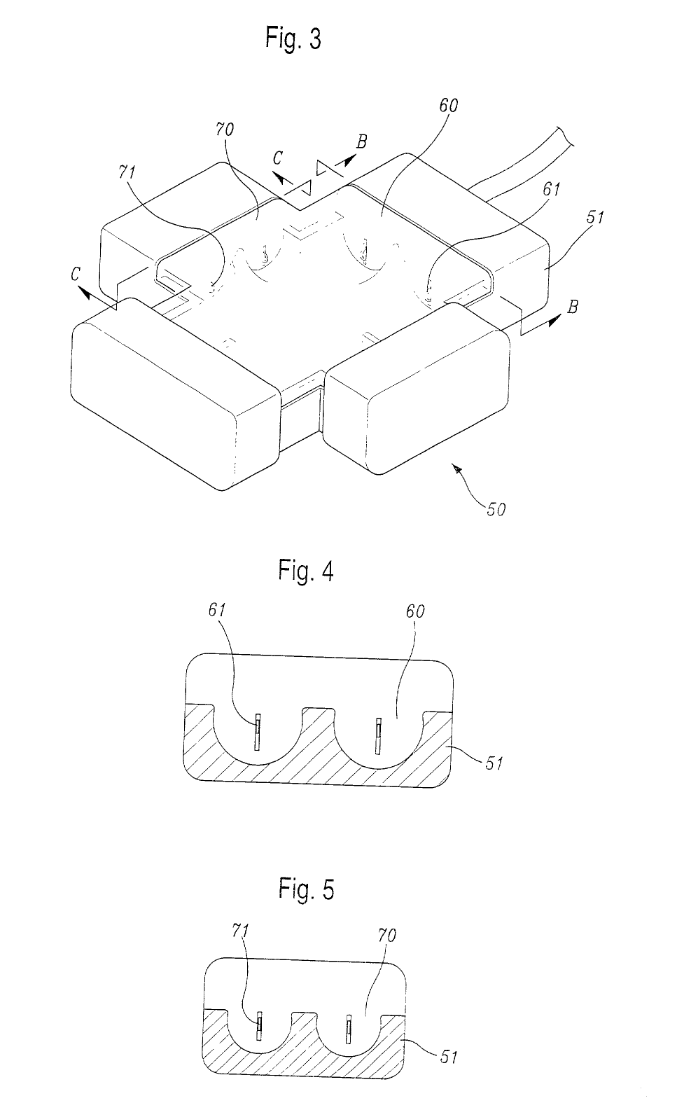

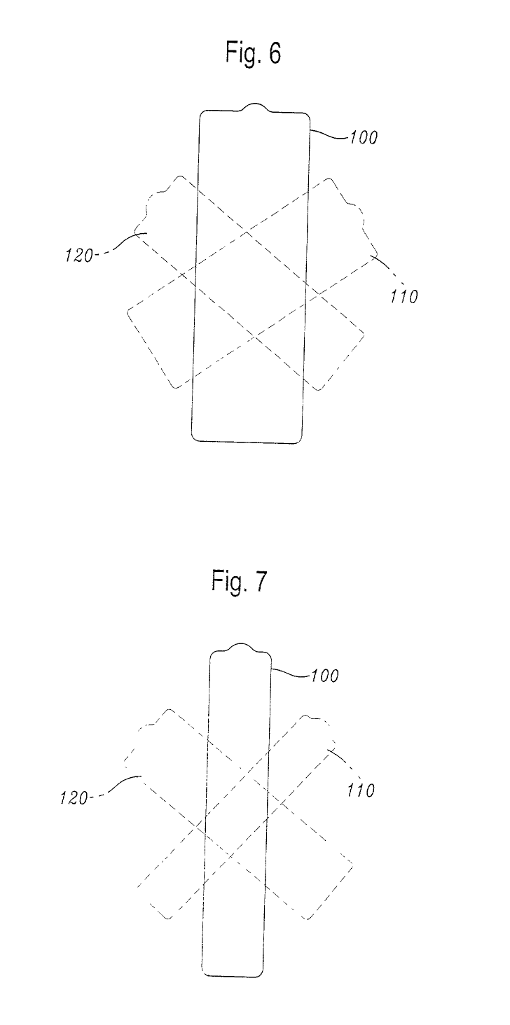

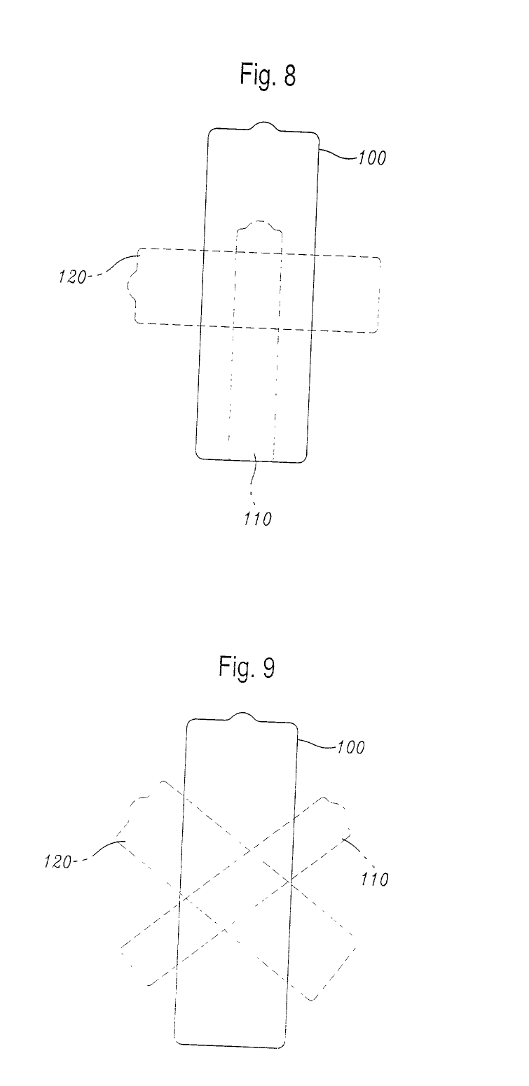

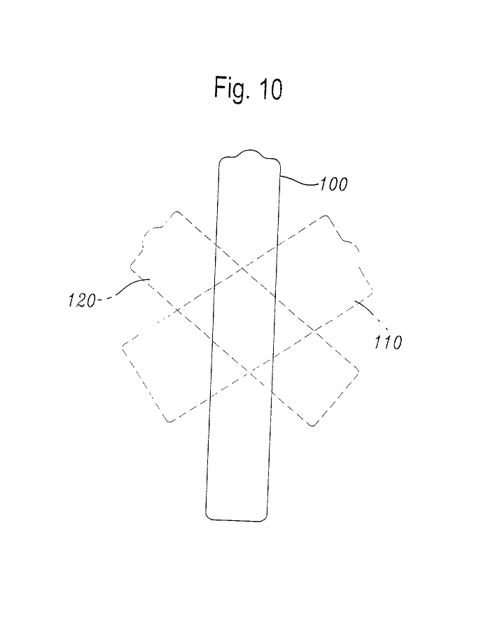

FIG. 3 is a view of the charger according to the present utility design

FIG. 4 is a cross sectional view according to the line BB shown in FIG. 3.

FIG. 5 is a cross sectional view according to the line CC shown in FIG. 4.

FIGS. 6 to 10 are views showing slim type charger, ⅔ slim type charger and AA size charger according to the present utility design and its preferred embodiments.

### DESCRIPTION OF MAJOR PARTS OF THE DRAWINGS

50: charger

51: case

60: AA size holding part

61, 71: contact points

70: AAA size holding part

100: slim type charging battery

110: ⅔ slim type charging battery

120: AA size slim type charging battery

### DETAILED DESCRIPTION OF THE DESIGN

[Object of the Design]

[Technical Field of the Design and its Conventional Technology]

The present design is related to a charger, which charges charging batteries. In particular, the present design is about a charger in which different size batteries can be inserted into the battery holding part from the same height inside the charger. This is possible as the battery holding part is installed with different angle. Accordingly, the charging circuit is simplified, volume of the charger is reduced and also the putting in and out batteries is done easily.

In general, disposable batteries have been used in electronic appliances especially for the compact sized electronic appliances in order to provide power. However, various types of batteries, which can be charged and used repeatedly, have been developed according to its usages in order to protect the environment and save costs. Nickel-Cadmium batteries are reasonable in cost, easy to keep and carry, and cane be charged in a relatively short period of time and therefore it is used widely. In particular, the Nickel-cadmium batteries have big energy discharged per unit hour, can be recharged several times, and have longer durability when compared to other batteries so there is no battery which can replace the Nickel-cadmium battery in the industrial filed where the Nickel-cadmium batteries are especially widely used. For example, Nickel-cadmium batteries are widely used in products like camera flash, codeless telephone, subsidiary power for satellite, electric driver, vacuum cleaner, underwater flash, and remote controlled miniature models like cars, airplanes, ship etc which requires big energy in a short time. If nickel batteries are recharged when it is not fully discharged, “memory phenomena” which means reduction in capacity due to adherence of counter current material leads to reduction in number of charging times. FIG. 1 is a view of conventional charger and the FIG. 2 is a cross sectional view according to the line AA of the FIG. 1. In the conventional charger 10 as shown in FIGS. 1 and 2, an AA size battery holding part 20a in which two AA size charging batteries can be charged in formed inside a case 11 and an AAA size battery holding part 20b in which two AAA size batteries can be charged is formed at the lower part of the AA size battery holding part 20a slightly overlapping one another. In the chargers of the conventional technology, AA size charging battery is charged by properly inserting the battery to fit the plus and minus contact points 21 into the AA size battery holding part 20a when charging the AA size charging battery. When charging the AAA size charging battery, it is done with the same method of charging the AA size battery but insert it into the AAA size battery holding part 20b. The plus, minus contact points 21 are connected to AA size battery holding part 20a and AAA size battery holding part 20b so that it is used as one charged capacity or compose the circuit using a sensor or a software program which distinguishes AA size charging battery and AAA size charging battery. If the later method is used, the circuit becomes complicated and the manufacturing cost increases. Another conventional method is to form and install another battery holding part which can hold different size batteries and hinge connect it to the case. This method also cannot overcome the problem of complicated circuit and the increase in manufacturing cost. Other than the two problem described above, there is a problem that the thickness and volume of the charger increases as battery holding part 20 has to be formed sequentially, on top of the other, in the conventional chargers. One last problem of the conventional charger is that the charged batteries have to be taken out using fingers so if the charger has enough space to insert fingers batteries can be taken out relatively easily but there is a problem that the volume of the charger gets big. On the other hand, if there is no space to insert fingers, the problem of volume is reduced a little bit, but it would be inconvenient to take out the charged batteries.

[Technical Object To Be Achieved By The Design]

The present utility model is designed to overcome the conventional problems described above. Each battery holding part is formed and installed to cross one another with a certain angle and it allows charging different sizes of charging batteries. Therefore, the circuit is simplified and provides users with minimized charger in which the volume of the case is reduced.

[Composition of the Design]

The present design is related to a charger which charges chargeable batteries in which battery holding parts are formed and installed inside the charger. In particular, a crossing battery holding part in which different size batteries can be inserted is formed to cross one another with a certain angle. The charger according to the present utility model characterizes in that the angle between the battery holding part and the crossing battery holding part is 90 degrees. In addition, the plus and minus contact points installed at the end of the battery holding part and the crossing battery holding part are not connected to one another but are individual. Hereinafter, the present utility model will be described in detail within the preferred embodiments referring to the attached drawings. FIG. 3 is the view of the charger according to the present utility model. FIG. 4 is the cross sectional view according to the line BB of the FIG. 3. FIG. 5 is the cross sectional view according to the line CC of the FIG. 3.

The charger 50 according to the present utility model has a case 51 formed in a cross type as shown in FIGS. 3 and 5. In the case 51, an AA size battery holding part 60 in which two AA size batteries can be inserted is formed and an AAA size battery holding part 70 in which two AAA size batteries can be inserted is formed to cross the AA size battery holding part 60 in 90 degrees. The plus and minus contact points 61 and 71 are formed at the ends of the each battery holding parts 60 and 70. Different size battery holding parts 60, 70 are formed inside the case 51 as shown in FIGS. 4 and 5. A battery holding part 60 which can AA size charging battery is shown in FIG. 4 and a battery holding part 70 which can hold AAA size charging battery is shown in FIG. 5. Therefore, when charging the AA size charging battery, one or more AA size charging battery is inserted in to the AA size battery holding part 60 and when charging the AAA size charging battery, one or more AAA size charging battery is inserted into the AAA size battery holding part 70 to carry out charging for the batteries. Here, the contact points 61 and 71 are installed separately according to the capacity of each of the batteries, charging is done according to the types and capacities of the batteries. FIGS. 6 and 10 show the preferred embodiments according to the charger of the present utility. While one battery is being charged, other batteries cannot be charged and each terminal is individually installed so that batteries are inserted into the battery holding part separately. FIG. 6 shows a charger structure of the present utility in which slim type charging battery 100, AA size charging battery 120, and ⅔ slim type battery 110 can be charged. The slim type charging battery 100 is inserted in to the battery holding part crosswise and the AA size charging battery 120 and ⅔ slim type charging battery 110 are inserted into the battery holding part maintaining a certain degree from the slim type battery 110. FIG. 7 is another example of the present utility similar to the one shown in FIG. 6. In the charger of FIG. 7, the slim type charging battery 100 and the ⅔ slim type charging battery 110 are inserted into the battery holding part vertically to be charged. In FIG. 8, the slim type charging battery 100 and the ⅔ slim type charging battery 110 can be inserted into the battery holding part from different height and the AA size charging battery 120 is inserted into the battery holding part within 90 degrees from the batteries 100 and 110. In other words, the ⅔ slim type battery 110 is located at the bottom and the slim type charging battery 110 and the AA size charging battery 120 are inserted on top of the battery 11o to be charged. FIG. 9 shows a charger of the present utility which is similar to the utility shown in FIGS. 6 and 7. The slim type charging battery 100 is inserted in to the battery holding part crosswise and the ⅔ slim type charging battery 110 is inserted in to the battery holding part vertically to be charged. Different from the FIG. 9, the slim type charging battery 100 is inserted into the battery holding part vertically and the ⅔ slim type charging battery 110 is inserted into the battery holding part crosswise to be charged in FIG. 10.

### EFFECT OF THE UTILITY

The charger according to the present utility has different battery holding parts for batteries according to its size and the battery holding parts are formed to cross one another from the same height and as a result the thickness of the charger is reduced. In the charger, the contact points, which are installed inside each of the different sized battery holding parts, are installed individually so the charger effectively charges the batteries according to its type and capacity. In addition, the fully charged batteries are easily taken out from the battery holding parts as there is enough space for the fingers to move around at the battery holding part in which the batteries are not inserted. The present utility can be is not limited to the boundaries of the preferred embodiments illustrated in this specification unless it does not extend beyond the scope of the present utility.

What is claimed:

1. A charger, which comprises a battery holding part in which a certain sized charging batteries can be inserted, characterizes in forming a crossing battery holding part in which different sized batteries can be inserted.

2. The charger according to claim 1 in which
a crossing angle between the crossing battery holding part and the battery holding part is 90 degrees.

3. The charger according to claim 1 in which
contact points of the plus and minus poles installed at the ends of the battery holding part and the crossing battery holding part are not connected to each other.
